(19) United States
(12) Patent Application Publication
(10) Pub. No.: US 2003/0156518 A1
(43) Pub. Date: Aug. 21, 2003

(54) Optical disk drive with restricted rotation speed based on information obtained from a disk thereon

(75) Inventors: Kenichi Ishizuka, Tokyo (JP); Shinichi Katsuda, Tokyo (JP)

Correspondence Address: YOUNG & THOMPSON, 745 SOUTH 23RD STREET 2ND FLOOR, ARLINGTON, VA, 22202

(73) Assignee: NEC CORPORATION, Tokyo (JP)

(21) Appl. No.: 10/338,711

(22) Filed: Jan. 9, 2003

(30) Foreign Application Priority Data
Feb. 20, 2002 (JP) 2002-042806

(51) Int. Cl. G11B 7/00

(52) U.S. Cl. 369/53.37

(57) ABSTRACT

An optical disk drive restricts its rotation speed based on information obtained from a disk. The optical disk drive includes a checking unit that checks whether disk information stored on an optical disk is registered in a database, and a restriction unit that restricts, if the disk information is not in the database, a maximum rotation speed of the optical disk drive.

### BACKGROUND OF THE INVENTION

The present invention relates to an optical disk drive, and more particularly, to an optical disk drive in which it is possible to write information on an optical disk.

We have seen a remarkable development of optical disk drive, technology in which designated information is written on an optical disk, including CD-R/RW drives, DVD-R/RAM/RW drives, video disk recorders such as DVD recorders, and the like. In particular, the data read/write speed of the optical disk drive is increasing day by day, and probably the speed will be further increased.

However, a high rotation speed, over 10,000 rpm for example, was not assumed at the time when CD and DVD technology was initially standardized, and disk strength to withstand such high-velocity rotation should not necessarily be assumed. It is anticipated that an optical disk may be destroyed or deformed due to centrifugal force, if it is rotated too fast.

If an old, low strength optical disk is loaded on a high speed optical disk drive, the disk may be damaged or destroyed due to centrifugal force. This may cause data to disappear and may damage the optical disk drive due to scattering of broken disk pieces.

### SUMMARY OF THE INVENTION

The present invention has an object to provide an optical disk drive that addresses the problems of above-noted conventional arts, and in particular, that prevents destruction of disks that are not in tended to be operated at the high speeds of newer disk drives.

According to one aspect of the present invention, an optical disk drive includes a checking unit which checks whether disk information previously stored on an optical disk is registered in a database, and a restriction unit which restricts a maximum rotation speed of the optical disk drive, if the disk information is not in the database.

### BRIEF DESCRIPTION OF THE DRAWINGS

These and other objects, features and advantages of the invention will become more apparent from the following detailed description when taken in conjunction with the accompanying drawings, in which:

FIG. 1 is a block diagram showing a configuration of one embodiment of the present invention; and

FIG. 2 is a flowchart showing operations of one embodiment of the present invention.

### DESCRIPTION OF THE PREFERRED EMBODIMENTS

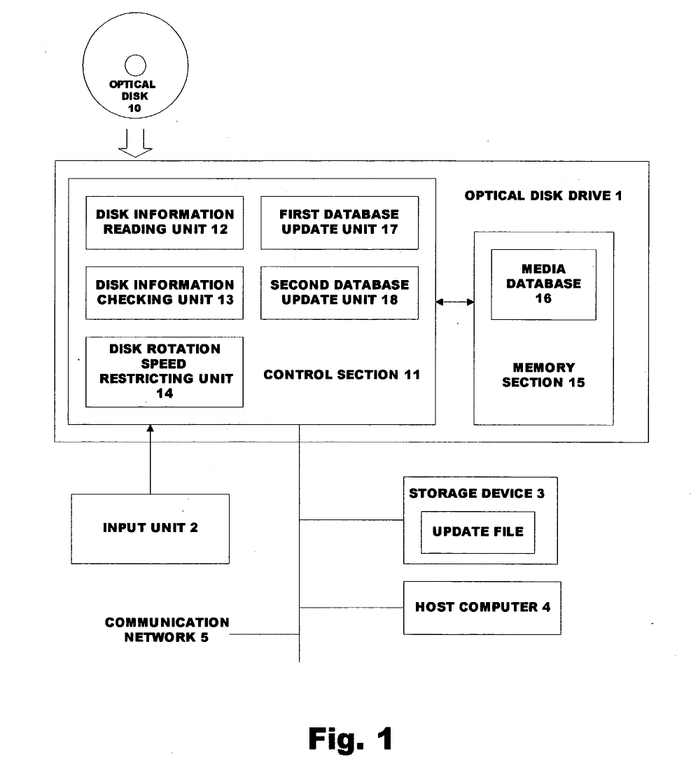

Referring to FIG. 1, an optical disk drive 1 writes designated information on an optical disk 10, such as a CD-R/RW media, a DVD-R/RAM/RW media. The optical disk drive 1 includes a control section 11 and a memory section 15. The control section 11 has a predetermined calculation processing ability for controlling operation of the optical disk drive 1. The memory section 15 has a predetermined data capacity for storing data. For example, the optical disk drive 1 may be built in a personal computer or externally provided, as a device of the computer, and it may record data on the optical disk 10, in accordance with a command from the computer. As a matter of course, it is possible to read the data recorded on the optical disk 10.

The optical disk drive 1 may be connected to an input unit 2 for a user to input data from outside or to an additional storage device 3 or a host computer which uses the optical disk drive 1 as recording device. Furthermore, the optical disk drive 1 may be connected to a communication network 5, and it is possible to access different computers on the communication network 5.

The optical disk 10 is, for example, a CD-R/RW media, a DVD-R/RAM/RW media and the like. The disk 10 is capable of being read and written on by use of a laser beam. The disk 10 stores disk information for identifying the disk 10. This disk information is, for example, six-digit numerical information. The disk information includes information, such as a disk ID, which is peculiar to the optical disk (name of manufacture, date of manufacture, and the like). Moreover, the disk information is stored on a commonly used part of the optical disk.

The memory section 15 includes a memory, such as nonvolatile memory, e.g., EEPROM. The memory section 15 has a media database 16. The media database 16 stores the disk information of the optical disks which are capable of rotating up to a predetermined rotation speed. More specifically, a strength examination is conducted in advance to see whether it is possible to rotate the disk at 10,000 rpm or more. After it is assured that an optical disk is capable of rotating at not less than the above rotation speed, the disk information for the optical disk is stored in the media database 16. For example, if it is verified by experiments that all the optical disk produced by a manufacturer x, on or after the date y, are resistant to 10,000 rpm or more, then this disk information is stored in the media database 16.

If the above conditions (such as name of manufacturer, and date of manufacturing) can be identified by only a part of the disk information, that part may be clearly stored, and the other parts may be stored as a wild card. Accordingly, if only the part concerned matches, it is possible to confirm whether the loaded disk has a predetermined strength.

In addition, the memory section 15 stores a restricted value of a maximum rotation speed of the optical disk drive 1. In other words, the restricted value of the maximum rotation speed is a value of rotation speed that is lower than the normal rotation speed. This value is set at a disk rotation speed restricting unit 14 and is a rotation speed that considers the strength of the loaded optical disk. For example, this restricted rotation speed may be 7,000 rpm or the like, at which a conventional disk resists destruction or deformation. The value for restricting the maximum rotation speed is not limited to be stored in the memory section 15, but it may also be stored in a nonvolatile memory (not shown) within the control section 11.

The control section 11 includes a disk information reading unit 12 which reads the disk information from the optical disk 10, a disk information checking unit 13 which checks whether the disk information on the disk 10 is registered in the media database 16, and a disk rotation speed restricting unit 14 which controls rotation of the optical disk 10 by restricting the maximum rotation speed, when it is determined at the disk information checking unit 13 that the disk information of the optical disk 10 is not registered in the media database 16. An operating program is stored in advance in the memory section 15 and the program can be implemented by being read into the control section 11.

The disk information reading unit 12 reads the aforementioned disk information from the optical disk 10 when the optical disk 10 is inserted into the optical disk drive 1. Then, the disk information thus read is stored temporarily in a register (not shown) within the control section 11.

The disk information checking unit 13 reads the media database 16, and compares the database to the disk information read from the disk 10. Then, it conducts a search within the media database 16, to check whether information matching the disk information exists.

The disk rotation speed restricting unit 14 controls a rotation of the optical disk 10 by reducing the maximum rotation speed of the optical disk drive 1 when the disk 10 does not have sufficient strength to be resistant to the rotation speed of the optical disk drivel, or when such resistance is unknown. In other words, the disk rotation speed restricting unit 14 controls the rotation in accordance with an upper limit of the rotation speed of the disk 10. The unit 14 is activated when the information corresponding to the disk information read-out from the optical disk 10 is not stored in the media database 16 at the aforementioned disk information collating function 13. For example, as a result of collation, if such information is not stored in the media database 16, a flag indicating that state is set. When the flag is set, the restricted maximum rotation speed is read-out from the memory section 15, and the maximum rotation speed of the optical disk drive 1 is set to the read-out restricted rotation speed. That is, the maximum rotation speed is reduced from the normal maximum rotation speed.

The optical disk drive 1 further includes a unit for writing given information into the optical disk 10 and reading out information from the disk 10. During such processing, a rotation speed of the disk 10 is controlled and the maximum rotation speed is set as a predetermined maximum rotation speed (R_{M}) or as a newly set restricted rotation speed (R_{L}) when the rotation speed is restricted by the aforementioned disk rotation speed restricting unit 14.

Furthermore, the control section 11 includes a first database update unit 17 for updating the media database 16 based on the information input via the input unit 2. Accordingly, the aforementioned media database 16 is rewritable, in other words can be updated. Updated or new disk information is input by a user from the input unit 2, and the new or updated disk information is added to the media database 16. Then, similarly, after the disk information, which has already been registered in the media database 16, is input, such disk information can be deleted from the media database 16.

Furthermore, the control section 11 is also provided with a second database update unit 18 for updating a media database 16 based on information imported from an additional external device. The second database update unit 18 registers into the media database 16 of its own, the disk information of the optical disk 10, the strength of which is assured, the disk information being transmitted from a storage device 3, a host computer 4 or the like, which are connected to the optical disk drive 1. In other words, an update file to be newly registered in the media database 16 is imported from the external device to update the contents of the database 16. At this time, the control section 11 may import the update file for itself by accessing the external device at a predetermined interval, or may import the update file by receiving the update file simply transmitted.

The input unit 2 may also function as a release operation unit that can be operated from outside to remove or not allow a speed restriction imposed by the disk rotation speed restriction unit 14. In other words, the input unit 2 may include a button or the like as a release operation unit. When the release operation unit is operated, for example by a user pressing the unit, a signal indicating the release operation is transmitted to the control section 11, and activation of the disk rotation speed restricting unit 14 is prevented. That is, even when an optical disk 10 whose information is not registered in the database 16 is inserted into the optical disk drive 1, the maximum rotation speed of the disk is not restricted when the user recognizes that the disk 10 has a sufficient strength and operates the release operation unit.

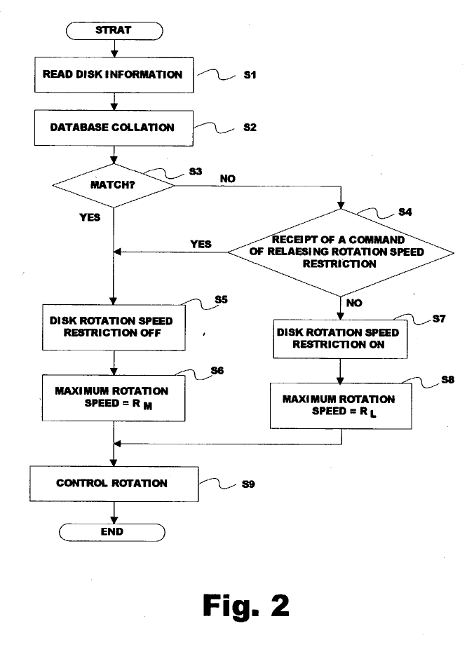

In operation, referring to FIG. 2, firstly, the user inserts a disk 10 into the optical disk drive 1. The drive 1 reads the disk information of the disk 10 and stores the information in the register (step S1).

Subsequently, the media database 16 is read-out from the memory section 15 and the media database is collated with the disk information read-out from the disk 10 (Step S2). The two are compared to determine whether the disk information stored on the optical disk 10 is previously registered (Step S3).

At this time, if the disk information is already registered, the rotation speed of the optical disk 10 inserted in the optical disk drive 1 is not restricted (Step S5), and a setting is made so that a rotation up to a maximum rotation speed R_{M} provided in advance is possible, within a range that the entire drive 1 itself operates safely (Step S6). For example, the maximum rotation speed R_{M} is maintained as a predetermined speed, 13,000 rpm, and the drive 1 can rotate the disk 10 as appropriate up to this value.

On the other hand, if the disk information read-out from the disk 10 is not registered, the aforementioned flag is set, and a restriction control of the disk rotation speed is imposed by detecting that this flag is set (Step S7). In other words, when the control section 11 sets the flag and detects it, the maximum rotation speed is set to the restricted rotation speed R_{L}. The rotation speed R_{L} is a value of 7,000 rpm for example, and stored in the memory section 15. In this case, however, if the user recognizes that the inserted disk 10 can resist rotation speed of 10,000 rpm or more, the aforementioned release operation unit is operated, and a signal is transmitted to the disk rotation speed restricting unit 14 (step S4), and then, the rotation is controlled without restricting the maximum rotation speed of the disk (steps S5, 6). That is, the disk is rotated up to the predetermined rotation speed R_{M}.

Accordingly, under a condition that the maximum rotation speed of the disk on the optical disk drive 1 is set to any one of the values (R_{M}, R_{L}) (Steps 6, 8), the disk rotation speed is controlled (Step S9). Here, it should be noted that the aforementioned values of the maximum rotation speed of the optical disk drive 1 are given by way of example, and they are not limited to these values.

As described above, a disk having no assurance of strength or durability, i.e., the disk having disk information stored therein is not registered, is inserted, the upper limit of the rotation speed of the disk drive 1 is restricted by detecting that the disk is not registered. Since a rotation over the restricted rotation speed is not permitted, the disk to be rotated is prevented from being destroyed or deformed. In addition, data stored in the media can be protected as well as preventing damage to the drive 1 itself.

Further, when the disk information of optical disk 10, as to which a predetermined strength is already proved, is received from the input unit 2, additional devices 3, 4, or further from other computers on the network 5, such information is registered in the media database 16. Then, it is used as target information to be collated with the disk information at the disk information checking unit 13. At this time, the optical disk drive 1 accesses such additional devices 3 and 4, at a predetermined time interval to confirm existence or nonexistence of update information, so as to receive the update information from the additional device. Then, if there is any new disk information, the drive 1 receives the disk information and updates the media database 16 as described above.

While this invention has been described in conjunction with the preferred embodiment described above, it will now be possible for those skilled in the art to put this invention into practice in various other manners.

What is claimed is:

1. An optical disk drive comprising:
a checking unit that checks whether disk information stored on an optical disk loaded in the optical drive is registered in a database; and
a restriction unit that restricts a maximum rotation speed of the optical disk drive when said disk information is not stored in said database.

2. The optical disk drive of claim 1, wherein said database is in the optical disk drive.

3. The optical disk drive of claim 1, wherein the maximum rotation speed restricted by said restriction unit is stored in the optical disk drive.

4. The optical disk drive of claim 1, further comprising:
a database update unit which updates said database based on information from an input unit.

5. The optical disk drive of claim 1, further comprising:
a database update unit which updates said database based on information imported from an external device.

6. The optical disk drive of claim 1, further comprising a release unit that prevents activation of said restriction unit under control of a user.

7. A method of controlling a rotation speed of an optical disk drive comprising the step of:
reading disk information stored on an optical disk;
checking whether the disk information is registered in a database; and
restricting a maximum rotation speed of the optical disk drive if the disk information is not in the database.

8. A computer program product having computer readable media with computer readable code stored thereon, said computer readable code causing an optical disk drive:
to read disk information stored on an optical disk;
to check whether the disk information is registered in a database; and
to restrict a maximum rotation speed of the optical disk drive if the disk information is not in the database.
